(19) United States
(12) Patent Application Publication
(10) Pub. No.: US 2021/0332251 A1
(43) Pub. Date: Oct. 28, 2021

(54) Coated Substrates and Methods of Preparing the Same

(71) Applicant: PPG Industries Ohio, Inc., Cleveland, OH (US)

(72) Inventors: Troy James Larimer, North Huntingdon, PA (US); John R. Schneider, Allison Park, PA (US); Anthony M. Chasser, Greensburg, PA (US); Brian Edward Woodworth, Glenshaw, PA (US); Justin Jonathan Martin, Irwin, PA (US); Steven Joseph Lemon, Lower Burrell, PA (US); Craig Daniel Niederst, Valencia, PA (US); Corey James DeDomenic, Monroeville, PA (US); Brian C. Okerberg, Gibsonia, PA (US); Steven R. Zawacky, Cranberry Township, PA (US)

(73) Assignee: PPG Industries Ohio, Inc., Cleveland, OH (US)

(21) Appl. No.: 17/271,349

(22) PCT Filed: Aug. 27, 2019
(86) PCT No.: PCT/US2019/048385

§ 371 Date: Feb. 25, 2021

Related U.S. Application Data
(60) Provisional application No. 62/723,073, filed on Aug. 27, 2018.
(60) Provisional application No. 62/723,079, filed on Aug. 27, 2018.

(51) Int. Cl. C09D 5/44; C09D 5/00; B05D 7/14; B05D 7/00; C25D 13/12; C25D 13/04

(52) U.S. Cl. CPC C09D 5/4465; C09D 5/4411; C09D 5/002; C25D 13/04; B05D 7/14; B05D 7/54; C25D 13/12; C09D 5/4496

(57) ABSTRACT

The present invention relates to a substrate having (a) a first material applied to at least a portion of the substrate, and (b) a coating layer deposited from a liquid coating composition including a film-forming resin, and optionally a crosslinker that is reactive with the film-forming resin, in direct contact with at least a portion of the substrate to which the first material has been applied. The first material is (i) a catalyst that catalyzes cure of the liquid coating composition, (ii) a component reactive with the film-forming resin and/or the crosslinker of the liquid coating composition, and/or (iii) a rheology modifier.

### FIELD OF THE INVENTION

The present invention relates to substrates and methods for treating substrates, sealing surfaces of substrates, decreasing sag resistance, improving adhesion, and improving edge coverage.

### BACKGROUND OF THE INVENTION

Coatings are applied to substrates to provide numerous properties including protective properties, decorative properties, and the like. Typically, these coatings are applied across the entire surface of the substrate including the edges and corners. However, the compositions that form these coatings often flow over the edges and corners resulting in low film build around these areas. As a result, the coatings pull away from the edges and corners of the substrate, so the properties provided by these coatings are not obtained or are diminished at the edges and corners. Thus, it is desirable to provide coated substrate with improved coating coverage over the edges and corners.

### SUMMARY OF THE INVENTION

The present invention relates to a substrate comprising: (a) a first material applied to at least a portion of the substrate; and (b) a coating layer deposited from a liquid coating composition in direct contact with at least a portion of the substrate to which the first material has been applied, the liquid coating composition comprising a film-forming resin, and optionally a crosslinker that is reactive with the film-forming resin. The first material is (i) a catalyst that catalyzes cure of the liquid coating composition, (ii) a component reactive with the film-forming resin and/or the crosslinker of the liquid coating composition, and/or (iii) a rheology modifier.

Moreover, the present invention relates a method for treating a substrate, sealing a surface of a substrate, decreasing sag resistance, improving adhesion, and/or improving edge coverage comprising: (a) contacting at least a portion of the substrate with a first material; and (2) directly contacting at least a portion of the substrate in contact with the first material with a liquid coating composition comprising a film forming resin, and optionally a crosslinker that is reactive with the film forming resin, to form a coating layer, in which the first material is (i) a catalyst that catalyzes cure of the liquid coating composition, (ii) a component reactive with the film-forming resin and/or the crosslinker of the liquid coating composition, and/or (iii) a rheology modifier.

The present invention also relates to a method of treating a coil comprising: (a) contacting at least a portion of the coil with a first material; (b) rolling the coil; (c) unrolling the coil at later period of time; (d) directly contacting at least a portion of the coil in contact with the first material with a liquid coating composition to form a coating layer of the liquid coating composition on the coil. The liquid coating composition comprises a film-forming resin, and optionally a crosslinker that is reactive with the film-forming resin. The first material is (i) a catalyst that catalyzes cure of the liquid coating composition, (ii) a component reactive with the film-forming resin and/or the crosslinker of the liquid coating composition, and/or (iii) a rheology modifier.

### DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “a” first material, “a” coating composition, and the like refer to one or more of any of these items.

As previously described, the present invention relates to a substrate comprising: (a) a first material applied to at least a portion of the substrate; and (b) a coating layer deposited from a liquid coating composition comprising a film-forming resin, and optionally a crosslinker reactive with the film-forming resin, that is in direct contact with at least a portion of the substrate to which the first material has been applied. That is, the liquid coating composition is applied directly to at least a portion of the substrate to which the first material is applied before application of any other intermediate layers. As used herein, a “liquid coating composition” refers to a coating composition in liquid form including a liquid solution or dispersion as compared to solid form such as a powder.

In accordance with the present invention, the interfacial flow of the liquid coating composition in contact with at least a portion of the substrate to which the first material has been applied is lower than the interfacial flow of the same liquid composition that is in contact with an identical substrate with the exception that no first material has been applied or with a portion of the same substrate to which the first material has not been applied. The “interfacial flow” refers to the flow of the liquid coating composition at an interface of the first material which has been applied to the substrate and the liquid coating composition. The viscosity of the liquid coating composition can also be higher than the viscosity of the same liquid coating composition without contact to the first material.

The first material of the present invention can be selected to interact with the desired liquid coating composition. The liquid coating composition is typically a curable liquid coating composition that comprises a binder. As used herein, the terms “curable”, “cure”, and the like, as used in connection with a liquid coating composition, means that at least a portion of the components that make up the liquid coating composition are polymerizable and/or crosslinkable including self-crosslinkable polymers.

The curable liquid coating composition of the present invention can be cured at ambient conditions, with heat, increased or reduced pressure, chemically such as with moisture or with other means such as actinic radiation, and combinations thereof. As used herein, “ambient conditions” refers to the conditions of the surrounding environment (e.g., the temperature, humidity, and pressure of the room or outdoor environment in which the substrate is located). The term “actinic radiation” refers to electromagnetic radiation that can initiate chemical reactions. Actinic radiation includes, but is not limited to, visible light, ultraviolet (UV) light, infrared radiation, X-ray, and gamma radiation.

Further, a “binder” refers to a constituent material that typically holds all coating composition components together upon cure. The binder includes one or more film-forming resins. As used herein, a “film-forming resin” refers to a resin that can form a self-supporting continuous film on at least a horizontal surface of a substrate upon removal of any diluents or carriers present in the composition and/or upon curing. The term “resin” is used interchangeably with “polymer,” and the term polymer refers to oligomers, homopolymers (e.g., prepared from a single monomer species), copolymers (e.g., prepared from at least two monomer species), terpolymers (e.g., prepared from at least three monomer species), and graft polymers.

The liquid coating compositions used with the present invention can include any of a variety of thermosetting liquid coating compositions known in the art. As used herein, the term “thermosetting” refers to compositions that “set” irreversibly upon curing or crosslinking, wherein polymer chains of polymeric components are joined together by covalent bonds. This property is usually associated with a cross-linking reaction of the composition constituents often induced, for example, by heat or radiation. Once cured, a thermosetting resin will not melt upon the application of heat and is insoluble in solvents.

The liquid coating compositions used with the present invention can also include thermoplastic liquid coating compositions. As used herein, the term “thermoplastic” refers to compositions that include polymeric components that are not joined by covalent bonds and, thereby, can undergo liquid flow upon heating.

Non-limiting examples of suitable film-forming resins that form at least a portion of the binder of the liquid coating composition include (meth)acrylate resins, polyurethanes, polyesters, polyamides, polyethers, polysiloxanes, epoxy resins, vinyl resins, copolymers thereof, and combinations thereof. As used herein, “(meth)acrylate” and like terms refers both to the acrylate and the corresponding methacrylate. Further, the film-forming resins can have any of a variety of functional groups including, but not limited to, carboxylic acid groups, amine groups, epoxide groups, hydroxyl groups, thiol groups, carbamate groups, amide groups, urea groups, isocyanate groups (including blocked isocyanate groups), ethylenically unsaturated groups, and combinations thereof. As used herein, “ethylenically unsaturated” refers to a group having at least one carbon-carbon double bond. Non-limiting examples of ethylenically unsaturated groups include, but are not limited to, (meth)acrylate groups, vinyl groups, and combinations thereof.

Thermosetting coating compositions typically comprise a crosslinker that may be selected from any of the crosslinkers known in the art to react with the functionality of one or more film-forming resins used in the liquid coating composition. As used herein, the term “crosslinker” refers to a molecule comprising two or more functional groups that are reactive with other functional groups and that is capable of linking two or more monomers or polymers through chemical bonds. Alternatively, the film-forming resins that form the binder of the liquid coating composition can have functional groups that are reactive with themselves; in this manner, such resins are self-crosslinking.

Non-limiting examples of crosslinkers include phenolic resins, amino resins, epoxy resins, triglycidyl isocyanurate, beta-hydroxy (alkyl) amides, alkylated carbamates, (meth)acrylates, isocyanates, blocked isocyanates, polyacids, anhydrides, organometallic acid-functional materials, polyamines, polyamides, aminoplasts, carbodiimides, oxazolines, and combinations thereof.

The liquid coating compositions can also be substantially free, essentially free, or completely free of any of the previously described film-forming resins and/or crosslinkers. For example, the liquid coating composition can be substantially free, essentially free, or completely free of a hydroxyl functional film-forming resin and/or an isocyanate functional crosslinker. The term “substantially free” as used in this context means the liquid coating composition contains less than 1000 parts per million (ppm), “essentially free” means less than 100 ppm, and “completely free” means less than 20 parts per billion (ppb) of a certain film-forming resin and/or crosslinker such as a hydroxyl functional film-forming resin and/or an isocyanate functional crosslinker, based on the total weight of the liquid coating composition.

The liquid coating composition can also comprise an electrodepositable coating composition. As used herein, an “electrodepositable coating composition” refers to a composition that is capable of being deposited onto an electrically conductive substrate under the influence of an applied electrical potential.

The electrodepositable coating composition may comprise an ionic salt group-containing film-forming polymer. The ionic salt group-containing film-forming polymer may comprise a cationic salt group containing film-forming polymer, an ionic salt group containing film-forming polymer, or a combination thereof.

The cationic salt group-containing film-forming polymer may be used in a cationic electrodepositable coating composition. As used herein, the term “cationic salt group-containing film-forming polymer” refers to polymers that include at least partially neutralized cationic groups, such as sulfonium groups and ammonium groups, that impart a positive charge. The cationic salt group-containing film-forming polymer may comprise active hydrogen functional groups. As used herein, the term “active hydrogen functional groups” refers to those groups that are reactive with isocyanates as determined by the Zerewitinoff test, and include, for example, hydroxyl groups, primary or secondary amine groups, and thiol groups. Cationic salt group-containing film-forming polymers that comprise active hydrogen functional groups may be referred to as active hydrogen-containing, cationic salt group-containing film-forming polymers.

Examples of polymers that are suitable for use as the cationic salt group-containing film-forming polymer in the present invention include, but are not limited to, alkyd polymers, acrylics, polyepoxides, polyamides, polyurethanes, polyureas, polyethers, and polyesters, among others.

More specific examples of suitable active hydrogen-containing, cationic salt group containing film-forming polymers include polyepoxide-amine adducts, such as the adduct of a polyglycidyl ethers of a polyphenol, such as Bisphenol A, and primary and/or secondary amines, such as are described in U.S. Pat. No. 4,031,050 at col. 3, line 27 to col. 5, line 50, U.S. Pat. No. 4,452,963 at col. 5, line 58 to col. 6, line 66, and U.S. Pat. No. 6,017,432 at col. 2, line 66 to col. 6, line 26, these portions of which being incorporated herein by reference. A portion of the amine that is reacted with the polyepoxide may be a ketimine of a polyamine, as is described in U.S. Pat. No. 4,104,147 at col. 6, line 23 to col. 7, line 23, the cited portion of which being incorporated herein by reference. Also suitable are ungelled polyepoxide-polyoxyalkylenepolyamine resins, such as are described in U.S. Pat. No. 4,432,850 at col. 2, line 60 to col. 5, line 58, the cited portion of which being incorporated herein by reference. In addition, cationic acrylic resins, such as those described in U.S. Pat. No. 3,455,806 at col. 2, line 18 to col. 3, line 61 and U.S. Pat. No. 3,928,157 at col. 2, line 29 to col. 3, line 21, these portions of both of which are incorporated herein by reference, may be used.

Besides amine salt group-containing resins, quaternary ammonium salt group-containing resins may also be employed as a cationic salt group-containing film-forming polymer in the present invention. Examples of these resins are those which are formed from reacting an organic polyepoxide with a tertiary amine acid salt. Such resins are described in U.S. Pat. No. 3,962,165 at col. 2, line 3 to col. 11, line 7; U.S. Pat. No. 3,975,346 at col. 1, line 62 to col. 17, line 25 and U.S. Pat. No. 4,001,156 at col. 1, line 37 to col. 16, line 7, these portions of which being incorporated herein by reference. Examples of other suitable cationic resins include ternary sulfonium salt group-containing resins, such as those described in U.S. Pat. No. 3,793,278 at col. 1, line 32 to col. 5, line 20, this portion of which being incorporated herein by reference. Also, cationic resins which cure via a transesterification mechanism, such as described in European Patent Application No. 12463B1 at pg. 2, line 1 to pg. 6, line 25, this portion of which being incorporated herein by reference, may also be employed.

Other suitable cationic salt group-containing film-forming polymers include those that may form photodegradation resistant electrodepositable coating compositions. Such polymers include the polymers comprising cationic amine salt groups which are derived from pendant and/or terminal amino groups that are disclosed in United States Patent Application Publication No. 2003/0054193 A1 at paragraphs [0064] to [0088], this portion of which being incorporated herein by reference. Also suitable are the active hydrogen-containing, cationic salt group-containing resins derived from a polyglycidyl ether of a polyhydric phenol that is essentially free of aliphatic carbon atoms to which are bonded more than one aromatic group, which are described in United States Patent Application Publication No. 2003/0054193 A1 at paragraphs [0096] to [0123], this portion of which being incorporated herein by reference.

The active hydrogen-containing, cationic salt group-containing film-forming polymer is made cationic and water dispersible by at least partial neutralization with an acid. Suitable acids include organic and inorganic acids. Non-limiting examples of suitable organic acids include formic acid, acetic acid, methanesulfonic acid, and lactic acid. Non-limiting examples of suitable inorganic acids include phosphoric acid and sulfamic acid.

The extent of neutralization of the cationic salt group-containing film-forming polymer may vary with the particular polymer involved. However, sufficient acid should be used to sufficiently neutralize the cationic salt-group containing film-forming polymer such that the cationic salt-group containing film-forming polymer may be dispersed in a dispersing medium such as an aqueous dispersed medium. For example, the amount of acid used may provide at least 20% of all of the total theoretical neutralization. Excess acid may also be used beyond the amount required for 100% total theoretical neutralization. For example, the amount of acid used to neutralize the cationic salt group-containing film-forming polymer may be ≥0.1% based on the total amines in the active hydrogen-containing, cationic salt group-containing film-forming polymer. Alternatively, the amount of acid used to neutralize the active hydrogen-containing, cationic salt group-containing film-forming polymer may be ≤100% based on the total amines in the active hydrogen-containing, cationic salt group-containing film-forming polymer. The total amount of acid used to neutralize the cationic salt group-containing film-forming polymer may range between any combination of values, which were recited in the preceding sentences, inclusive of the recited values. For example, the total amount of acid used to neutralize the active hydrogen-containing, cationic salt group-containing film-forming polymer may be 20%, 35%, 50%, 60%, or 80% based on the total amines in the cationic salt group-containing film-forming polymer.

As indicated, the ionic salt group containing film-forming polymer may also comprise an anionic salt group containing film-forming polymer. As used herein, the term “anionic salt group containing film-forming polymer” refers to an anionic polymer comprising at least partially neutralized anionic functional groups, such as carboxylic acid and phosphoric acid groups that impart a negative charge. The anionic salt group-containing film-forming polymer may comprise active hydrogen functional groups. Anionic salt group-containing film-forming polymers that comprise active hydrogen functional groups may be referred to as active hydrogen-containing, anionic salt group-containing film-forming polymers. The anionic salt group containing film-forming polymer may be used in an anionic electrodepositable coating composition.

The anionic salt group-containing film-forming polymer may comprise base-solubilized, carboxylic acid group-containing film-forming polymers such as the reaction product or adduct of a drying oil or semi-drying fatty acid ester with a dicarboxylic acid or anhydride; and the reaction product of a fatty acid ester, unsaturated acid or anhydride and any additional unsaturated modifying materials which are further reacted with polyol. Also suitable are the at least partially neutralized interpolymers of hydroxy-alkyl esters of unsaturated carboxylic acids, unsaturated carboxylic acid and at least one other ethylenically unsaturated monomer. Still another suitable anionic electrodepositable resin comprises an alkyd-aminoplast vehicle, i.e., a vehicle containing an alkyd resin and an amine-aldehyde resin. Another suitable anionic electrodepositable resin composition comprises mixed esters of a resinous polyol. Other acid functional polymers may also be used such as phosphatized polyepoxide or phosphatized acrylic polymers. Exemplary phosphatized polyepoxides are disclosed in U.S. Patent Application Publication No. 2009-0045071 at [0004]-[0015] and U.S. patent application Ser. No. 13/232,093 at [0014]-[0040], the cited portions of which being incorporated herein by reference. Also suitable are resins comprising one or more pendent carbamate functional groups, such as those described in U.S. Pat. No. 6,165,338.

It is appreciated that the electrodepositable coating composition may further comprise a crosslinker. The crosslinker may react with the reactive groups, such as active hydrogen groups, of the ionic salt group-containing film-forming polymer to effectuate cure of the coating composition to form a coating as previously described. The crosslinker can include, but is not limited to, any of the crosslinkers previously described such as at least partially blocked polyisocyanates.

It is appreciated that the liquid coating composition can be selected from a non-electrodepositable coating composition (i.e. not an electrodepositable coating composition that is deposited onto an electrically conductive substrate under the influence of an applied electrical potential).

The liquid coating composition can also include other optional materials. For example, the liquid coating compositions can also comprise a colorant. As used herein, “colorant” refers to any substance that imparts color and/or other opacity and/or other visual effect to the composition. The colorant can be added to the coating in any suitable form, such as discrete particles, dispersions, solutions, and/or flakes. A single colorant or a mixture of two or more colorants can be used in the coatings of the present invention.

Example colorants include pigments (organic or inorganic), dyes and tints, such as those used in the paint industry and/or listed in the Dry Color Manufacturers Association (DCMA), as well as special effect compositions. A colorant may include, for example, a finely divided solid powder that is insoluble, but wettable, under the conditions of use. A colorant can be organic or inorganic and can be agglomerated or non-agglomerated. Colorants can be incorporated into the coatings for example by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, diazo, naphthol AS, benzimidazolone, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, and mixtures thereof.

Example dyes include, but are not limited to, those that are solvent and/or aqueous based such as phthalo green or blue, iron oxide, bismuth vanadate, anthraquinone, and peryleneand quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions Division of Eastman Chemical, Inc.

Other non-limiting examples of components that can be used with the liquid coating compositions of the present invention include plasticizers, abrasion resistant particles, fillers including, but not limited to, micas, talc, and inorganic minerals, metal oxides, metal flake, various forms of carbon, anti-oxidants, hindered amine light stabilizers, UV light absorbers and stabilizers, surfactants, flow and surface control agents, thixotropic agents, reactive diluents, catalysts, reaction inhibitors, corrosion-inhibitors, and other customary auxiliaries. The liquid coating compositions can also be free of any one of the previously described additional components.

The liquid coating composition can also comprise components that may provide other properties in the final coating including components that may have a synergistic effect with the first material and further improve various properties such as, for example, film build along the edge of the substrate. For instance, the liquid coating composition can further comprise components which reduce the low shear viscosity of coating formulations such as, for example, cellulose acetate butyrate, montmorillonite clays, hectorite clays, or combinations thereof.

The liquid medium used to form the liquid coating composition can comprise a non-aqueous medium or an aqueous medium. As used herein, a “non-aqueous medium” refers to a liquid medium comprising less than 50 weight % water, based on the total weight of the liquid medium. Such non-aqueous liquid mediums can comprise less than 40 weight % water, or less than 30 weight % water, or less than 20 weight % water, or less than 10 weight % water, or less than 5% water, based on the total weight of the liquid medium. The solvents that make up more than 50 weight % or more of the liquid medium include organic solvents. Non-limiting examples of suitable organic solvents include polar organic solvents e.g. protic organic solvents such as glycols, glycol ether alcohols, alcohols; and ketones, glycol diethers, esters, and diesters. Other non-limiting examples of organic solvents include aromatic and aliphatic hydrocarbons.

In comparison to a non-aqueous liquid medium, an “aqueous medium” is a liquid medium that comprises greater than 50 weight % water, such as at least 60 weight % water, or at least 70 weight % water, or at least 80 weight % water, or at least 90 weight % water, or at least 95 weight % water, based on the total weight of the liquid medium.

It is appreciated that the film-forming resin(s), optional crosslinkers, and other optional components of the liquid coating composition may be dissolved and/or dispersed in the liquid medium. For example, a film-forming resin, a crosslinker reactive with the film-forming resin, and one or more additional components can be dissolved or dispersed in the liquid medium to form the liquid coating composition. The film-forming resin and crosslinker can also be selected based on the desired solubility within the liquid medium such that the film-forming resin and crosslinker can be dissolved or dispersed in the liquid medium. Additional optional materials, such as the additional components previously described, can also be selected based on the desired solubility within the liquid medium and the interactions with the film-forming resin and crosslinker in the liquid medium and/or final coating.

After being applied over the substrate to which the first material is applied, the liquid coating composition can be physisorbed onto the substrate. As used herein, “physisorbed”, “physisorption”, and like terms refers to a physical adsorption of a composition or material over the substrate in which the forces involved are intermolecular forces. Alternatively, the liquid coating composition can be chemisorbed onto the substrate. As used herein, “chemisorbed”, “chemisorption”, and like terms refers to a chemical adsorption of a composition or material over the substrate in which chemical or ionic bonds are formed.

As indicated, the first material can be selected to interact with the liquid coating composition. As used herein, the term “interact” and variants thereof refer to the ability of the first material to effect or influence any aspect of the liquid coating composition including, for example, its cure, physical/chemical properties, performance, appearance, and the like. For instance, the first material can comprise a catalyst that catalyzes cure of the liquid coating composition, a component that is reactive with at least one component of the liquid coating composition, and/or a rheology modifier that affects the flow of the liquid coating composition over the substrate.

As used herein, a “catalyst” refers to a material that increases the rate of reaction of one or more reactive components. Thus, the first material can comprise a catalyst that increases the rate of reaction of the film-forming resin(s) and optional crosslinker(s) that form a binder to thereby catalyze cure of the liquid coating composition. The catalyst used as all or part of the first material can therefore be selected based on the components used in the liquid coating composition. For example, the binder of the liquid coating composition can comprise a carboxylic acid functional compound and an epoxy functional compound reactive with the carboxylic acid functional compound, and the first material can comprise a catalyst comprising a phosphonium compound, a quaternary ammonium halide compound, an amine compound, an imidazole compound, a sulfonium compound, a compound comprising a transition metal and/or post-transition metal, or any combination thereof that increases the reaction rate between the acid and epoxy functionality.

A “phosphonium compound” refers to a salt comprising a phosphonium cation. Non-limiting examples of phosphonium compounds include tetrabutylphosphonium hydroxide and tetrabutylphosphonium bromide.

A “quaternary ammonium halide compound” refers a salt comprising a quaternary ammonium cation and a halogen anion. Non-limiting examples of quaternary ammonium halide compounds include dodecyltrimethylammonium chloride, benzyltrimethylammonium chloride, benzyldimethyloctylammonium chloride, and hexadecyltrimethylammonium bromide.

An “amine compound” refers to a compound comprising one or more primary, secondary, and/or tertiary amines. Non-limiting examples of amine compounds include 1,4-diazabicyclo[2.2.2]octane, 1,8-diazabicyclo[5.4.0]undec-7-ene, coco alkyl amine, benzyl dimethyl amine, and 1,1,3,3-tetramethylguanidine.

An “imidazole compound” refers to a compound comprising a substituted heterocyclic imidazole structure. Non-limiting examples of imidazole compounds include 1-methyl imidazole and 2-methyl imidazole.

A “sulfonium compound” refers to a salt comprising a sulfonium cation. A non-limiting example of a sulfonium compound is trimethylsulfonium iodide.

A “compound comprising a transition metal” refers to a compound comprising an element from one of Groups 3-12 (International Union of Pure and Applied Chemistry (IUPAC)) of the periodic table of the chemical elements, and a “compound comprising post-transition metal” refers to a compound comprising a post-transition metal element from one of Groups 13 and 14 (International Union of Pure and Applied Chemistry (IUPAC)) of the periodic table of the chemical elements. Non-limiting examples of compounds comprising a transition metal include non diammonium dihydroxy bis(lactate(2-)-O1,O2) titanate (2-), and zinc octoate. Non-limiting examples of compounds comprising a post-transition metal include stannous 2-ethylhexoate and tin(II) oxalate.

Other non-limiting examples include a liquid coating composition that comprises a hydroxyl functional compound and an isocyanate functional compound reactive with the hydroxyl functional compound, and a first material that comprises a tin catalyst. Yet another non-limiting example includes a liquid coating composition that comprises (meth)acrylic compounds and thiol functional compounds reactive with the (meth)acrylic functional compounds, and a first material that comprises an amine catalyst.

The first material can comprise a component that is reactive with at least one component of the liquid coating composition. For example, the first material can comprise a component that is reactive with a film-forming resin(s) and/or crosslinker(s) if used in the binder of the liquid coating composition. Non-limiting examples of such reactive components include a crosslinker, a resin such as a film-forming resin, a reactive diluent, a monomer, or any combination thereof.

It is appreciated that the functionality and types of crosslinkers, resins, reactive diluents, and monomers used in the first material can be selected to react with the functionality of one or more components of the liquid coating composition. Non-limiting examples include any of the resins and crosslinkers previously described provided that the resins or crosslinkers are reactive with the functionality of one or more components of the liquid coating composition. For example, the liquid coating composition can comprise a carboxylic acid functional film-forming resin and a hydroxyl functional or epoxy functional crosslinker, and the first material can comprise a crosslinker or other component reactive with the carboxylic acid, hydroxyl, and/or epoxy functionality such as, for example, an oxazoline functional crosslinker, a polycarbodiimide functional crosslinker, an isocyanate or blocked isocyanate functional crosslinker, an aminoplast crosslinker, an epoxy crosslinker, a beta-hydroxyalkylamide crosslinker, a hydroxyalkylurea crosslinker, glycoluril, or any combination thereof.

As previously described, the first material can comprise a rheology modifier. As used herein, a “rheology modifier” refers to a component that adjusts flow behavior of a composition by increasing the viscosity of the composition it is in contact with. Particularly, the rheology modifier used in the first material may increase the viscosity and adjust the flow of the liquid coating composition over the substrate. Non-limiting examples of rheology modifiers include silica, chemically modified silica (e.g. fumed silica), alumina, chemically modified alumina (e.g. fumed alumina), a hydrophobically modified ethylene-oxide polymer, a rubber latex such as styrene-butadiene rubber particles dispersed in a liquid medium, or any combination thereof.

The first material, such as a catalyst, reactive component, or rheology modifier, can be in solid or liquid form. The first material can also be dispersed or dissolved in an aqueous or non-aqueous liquid medium. The dispersions and solutions can comprise additional components including, but not limited to, surfactants and surfactant solubilizers.

When dispersed or dissolved in a liquid medium, the first material comprises at least 0.05 weight %, at least 0.1 weight %, or at least 1 weight %, based on the total weight of the dispersion or solution. The first material can further comprise up to 20 weight %, up to 15 weight %, up to 10 weight %, up to 8 weight %, up to 5 weight %, or up to 3 weight %, based on the total weight of the dispersion or solution. The first material can also comprise an amount within a range, for example, of from 0.05 weight % to 20 weight %, from 0.05 weight % to 10 weight %, from 0.1 weight % to 8 weight %, or from 0.1 weight % to 5 weight %, based on the total weight of the dispersion or solution.

The first material can be applied directly to the substrate without any intermediate layers between the first material and the substrate. For instance, the first material can be applied directly to a metal substrate, before or after the substrate is cleaned and/or treated as further described herein, but before application of any coating layers. The first material may also be applied during cleaning such as a component of the cleaner. The first material can be applied over the entire surface, edges, and corners of the substrate, or the first material can be applied over selected portions of the substrate. For example, the first material can be selectively applied over the edges and corners of the substrate so that the later applied liquid coating composition only interacts with the first material over the edges and corners of the substrate. The first material may also form a continuous or semi-continuous/discontinuous (i.e. non-continuous) layer over the substrate, or the first material may be applied over certain spots/areas of the substrate such as the edges and corners of the substrate. As used herein, the area referred to as the “edge” will vary based on the particular substrate but can include, e.g., the outer most lateral face of the substrate.

Once applied, the first material can be physisorbed onto the substrate in which the first material is physically adsorbed over the substrate through intermolecular forces. Alternatively, the first material is chemisorbed onto the substrate in which the first material is chemically adsorbed over the substrate through valence forces or chemical bonding.

The first material can also be incorporated into a pretreatment composition that is applied over the substrate. As used herein, a “pretreatment composition” refers to a composition that reacts with and chemically alters the substrate surface achieving at least one of the following: 1) formation of a protective layer; 2) improved substrate topography or reactivity to enhance coating adhesion; or 3) formation of a protective layer with improved coating adhesion in comparison to the substrate without pretreatment. Non-limiting examples of pretreatment compositions include compositions that comprise iron phosphate, manganese phosphate, zinc phosphate, a rare earth metal, permanganate or manganese, molybdate or molybdenum, zirconium, titanium, halfnium, lanthanides, a silane such as an alkoxysilane, hydrolyzed silanes and silane oligomers and polymers, metal chelates, trivalent chrome, silicate, phosphonic acids, chromate conversion coating, hydrotalcite, layered double hydroxide, metal oxides, other metals such as Group IV metals, or any combination thereof. Non-limiting examples of organic pretreatments may include chemically modified resins such as phosphatized epoxies, silanized epoxies and amino functional resins. The pretreatment may also include anodizing using, such as for example, sulfuric acid, nitric acid, hydrofluoric acid, tartaric acid, and other anodizing methods. The pretreatment composition can be in the form of a sol-gel, a liquid, or a solid. In some instances, the pretreatment may include metallic or metal oxide particles or nanoparticles within an organic matrix. In other instances, a pretreatment may contain or be sealed using an oligomeric or polymeric solution or suspension. In yet other instances, a pretreatment composition may contain small organic molecules with reactive functionality or those which function as corrosion inhibitors.

When the pretreatment composition is applied to the substrate and cured or dried, a surface region of the pretreatment layer applied to the substrate can have a greater concentration of the first material than a bulk region of the layer applied to the substrate. For example, the surface tension of the first material can be lower than the surface tension of other components of the pretreatment composition. As a result, the first material migrates to the surface of the pretreatment layer (i.e., moves through the bulk region to the surface region) such that a greater concentration of the first material can be found in the surface region, while the remaining amount of the first material is dispersed throughout the bulk region.

As used herein, the “surface region” means the region that is generally parallel to the exposed air-surface of the coated substrate and which has thickness generally extending perpendicularly from the surface of the cured coating beneath the exposed surface. A “bulk region” of the cured composition means the region which extends beneath the surface region and which is generally parallel to the surface of the coated substrate.

The pretreatment composition that includes the first material can comprise at least 0.05 weight %, at least 0.1 weight %, or at least 1 weight % of the first material, based on the total weight of the pretreatment composition. The pretreatment composition can further comprise up to 20 weight %, up to 15 weight %, up to 10 weight %, up to 8 weight %, up to 5 weight %, or up to 3 weight % of the first material, based on the total weight of the pretreatment composition. The pretreatment composition can also comprise an amount within a range, for example, of from 0.05 weight % to 20 weight %, from 0.05 weight % to 15 weight %, from 0.05 weight % to 10 weight %, from 0.1 weight % to 8 weight %, or from 0.1 weight % to 5 weight % of the first material, based on the total weight of the pretreatment composition.

The first material can also be applied over at least a portion of a substrate that has already had a previous pretreatment and/or coating applied. For example, the first material can be applied to a previously deposited pretreatment layer. Non-limiting examples of pretreatment layers include layers formed from any of the previously described pretreatment compositions. The first material can also be applied over a primer layer or another previously applied coating layer.

The first material may be applied in the absence of binder components that react to form a coating layer when cured such as through crosslinking. That is, the first material may be applied to the substrate or a previously applied coating as a non-film forming composition that does not form a separate coating layer. Thus, the first material may not be contained in a coating composition that can be cured to form a coating layer which is separate from the coating layer formed from the liquid coating composition applied directly over the substrate to which the first material has been applied. The dry film thickness of any potential resulting film, even if one or more binder components are present, may be less than 2.5 microns, less than 2 microns, less than 1.5 microns, less than 1 micron, or less than 0.5 micron, or less than 0.25 micron, or less than 0.1 micron.

The first material can be applied such that any other optional components applied together with the first material are substantially free, essentially free, or completely free of binder components that react to form a separate coating layer from the liquid coating layer when cured. The term “substantially free” as used in this context means the optional components applied with the first material contain less than 1000 parts per million (ppm), “essentially free” means less than 100 ppm, and “completely free” means less than 20 parts per billion (ppb) of binder components that react to form a separate coating layer from the liquid coating layer when cured, based on the total weight of all the components. For example, the first material can be applied such that any other optional components combined and applied together with the first material are substantially free, essentially free, or completely free of self-crosslinkable film-forming resins, a film-forming resin and a crosslinker reactive with the film-forming resin, and/or a film-forming resin reactive with the first material. The first material can also be applied such that any other optional components combined and applied together with the first material are substantially free, essentially free, or completely free of any type of film-forming resin. For instance, the first material can comprise a catalyst, a rheology modifier, and/or a crosslinker and any other optional components combined and applied together with the first material may be substantially free, essentially free, or completely free of a film-forming resin including any of the film-forming resins previously described.

One method for applying the first material to the substrate comprises dipping the substrate into a solution that contains the first material. The solution can be, for example, a pretreatment bath. As used herein, a “pretreatment bath” refers to a liquid bath containing the first material and that may optionally contain other components typically found in any type of pretreatment bath. Non-limiting examples of pretreatment baths that the first material can be incorporated into include a cleaner bath, a deoxidizer bath, a cleaner-coater bath, a rinse conditioner bath, a pretreatment coating bath, a rinsing bath, a sealing bath, or a deionized water rinsing bath. It will be appreciated that the first material can be added to any commercially available pretreatment products. It will also be appreciated that when spray pretreatments are used, immersion steps may be avoided entirely.

A “cleaner bath” is a bath comprising materials for removing grease, dirt, or other extraneous matter from the substrate. Non-limiting examples of materials for cleaning the substrate include mild or strong alkaline cleaners.

A “deoxidizer bath” is a bath comprising materials for removing an oxide layer found on the surface of the substrate such as acid-based deoxidizers. Non-limiting examples of acid-based deoxidizers include phosphoric acid, citric acid, nitric acid, fluoroboric acid, sulfuric acid, chromic acid, hydrofluoric acid, and ammonium bifluoride.

A “cleaner-coater bath” is a bath comprising materials for both cleaning and coating the substrate in the same stage. The cleaner-coater bath can therefore clean the substrate, for example as with a mild or strong alkaline cleaner, and then coat the substrate, for example with a pretreatment coating as previously described, in a single step. A non-limiting example of a cleaner-coater includes CHEMFOS 51HD, commercially available from PPG.

A “rinse conditioner bath” is a bath comprising activating agents for increasing the number of activation sites on the surface of the substrate for improved reaction with a pretreatment composition in order to enhance the protection of the substrate. A non-limiting example of a rinse conditioner bath is a bath comprising activating agents that increase the number of sites on the surface of the substrate where phosphate crystals form upon application of a phosphate coating.

A “pretreatment coating bath” refers to a bath comprising a composition for forming a protective coating layer over the surface of the substrate. Non-limiting examples of pretreatment compositions include any of the pretreatment compositions previously described.

A “rinsing bath” is a bath comprising a solution of rinsing agents to remove any residue after application of a cleaner or pretreatment layer such as a phosphate containing pretreatment layer. In some non-limiting examples, a rinsing bath may simply contain city water or de-ionized water.

A “sealing bath” is a bath comprising a solution or dispersion that is capable of affecting a material deposited onto a substrate in such a way as to enhance its physical and/or chemical properties. Sealer compositions generally utilize solubilized metal ions and/or other inorganic materials to enhance the protection (e.g., corrosion protection) of pretreated substrates. Non-limiting examples include CHEMSEAL 59 and CHEMSEAL 100, both which are commercially available from PPG.

A “deionized water rinsing bath” is a bath that comprises deionized water and can be utilized in multiple stages of a pretreatment process such as a final rinsing stage before drying.

Other non-limiting examples of application methods that can be used to apply the first material onto the substrate include: spraying, such as by incorporating the first material into a liquid formulation and using spray equipment; wiping where the first material is contained on and/or in a wipe and manually or automatically wiped; media blasting where the first material is a solid and is blasted onto the substrate's surface; electrostatically applied as a powder such as after being micronized into a powder with a desired particle size; brushing or rolling the first material over the substrate such as by incorporating the first material into a formulation (e.g., liquid or gel) that can be brushed or rolled; vapor deposition; electrodeposition where the formulation is liquid and is electro-coated; or any combination thereof. The first material may also be applied in-mold, during extrusion, during a calendaring, or during other processing of substrate materials.

As previously described, the method for applying the first material to the substrate can comprise dipping the substrate into a solution or dispersion that contains the first material. It is appreciated that the dispersion can be formed by first preparing the first material in solid form, such as a micronized powder, and then dispersing the solid first material into the liquid medium, such as to form a slurry.

The previously described methods of applying the first material can also be used in the absence of binder components as previously described. For example, the previously described baths can be substantially free, essentially free, or completely free of binder components that react to form a separate coating layer from the liquid coating layer when cured. The term “substantially free” as used in this context means that the methods such as the baths use or contain less than 1000 parts per million (ppm), “essentially free” means less than 100 ppm, and “completely free” means less than 20 parts per billion (ppb) of binder components that react to form a separate coating layer from the liquid coating layer when cured, based on the total weight of the components such as the components that form the baths.

The first material can be deposited onto the substrate by one or more of any of the previously described methods. The first material can also be applied alone or in combination with other treatments or coating processes. For example, the substrate of the present invention can be dipped or submerged into one or more of any of the previously described baths that include the first material during treatment of the substrate. For instance, the first material can be incorporated into: a cleaner bath to apply the first material directly over the surface substrate; a pretreatment coating bath to apply the first material over the substrate together with the pretreatment layer; or a final deionized water rinse to apply the first material over a pretreatment layer. In another non-limiting example, the substrate is sprayed or wiped with a solution that comprises the first material after application of a pretreatment layer or primer layer. In another non-limiting example, the first material may be present in more than one process step.

The substrate can undergo various treatments prior to application of the first material. For instance, the substrate can be alkaline cleaned, deoxidized, mechanically cleaned, ultrasonically cleaned, solvent wiped, roughened, plasma cleaned or etched, exposed to chemical vapor deposition, treated with an adhesion promoter, plated, anodized, annealed, cladded, or any combination thereof prior to application of the first material. The substrate can be treated using any of the previously described methods prior to application of the first material such as by dipping the substrate in a cleaner and/or deoxidizer bath prior to applying the first material. The substrate can also be plated prior to applying the first material. As used herein, “plating” refers to depositing a metal over a surface of the substrate. The substrate may be also be 3D printed.

The substrate according to the present invention can be selected from a wide variety of substrates and combinations thereof. Non-limiting examples of substrates include vehicles and automotive substrates, industrial substrates, marine substrates and components such as ships, vessels, and on-shore and off-shore installations, storage tanks, packaging substrates, aerospace components, wood flooring and furniture, fasteners, coiled metals, heat exchangers, vents, an extrusion, roofing, wheels, grates, belts, conveyors, grain or seed silos, wire mesh, bolts or nuts, a screen or grid, HVAC equipment, frames, tanks, cords, wires, apparel, electronic components, including housings and circuit boards, glass, sports equipment, including golf balls, stadiums, buildings, bridges, containers such as a food and beverage containers, and the like.

The substrates, including any of the substrates previously described, can be metallic or non-metallic. Metallic substrates include, but are not limited to, tin, steel, cold rolled steel, hot rolled steel, steel coated with zinc metal, zinc compounds, zinc alloys, electrogalvanized steel, hot-dipped galvanized steel, galvanealed steel, galvalume, steel plated with zinc alloy, stainless steel, zinc-aluminum-magnesium alloy coated steel, zinc-aluminum alloys, aluminum, aluminum alloys, aluminum plated steel, aluminum alloy plated steel, steel coated with a zinc-aluminum alloy, magnesium, magnesium alloys, nickel, nickel plating, bronze, tinplate, clad, titanium, brass, copper, silver, gold, 3-D printed metals, cast or forged metals and alloys, or combinations thereof.

Non-metallic substrates include polymeric, plastic, polyester, polyolefin, polyamide, cellulosic, polystyrene, polyacrylic, poly(ethylene naphthalate), polypropylene, polyethylene, nylon, EVOH, polylactic acid, other “green” polymeric substrates, poly(ethyleneterephthalate) (PET), polycarbonate, engineering polymers such as poly(etheretherketone) (PEEK), polycarbonate acrylobutadiene styrene (PC/ABS), polyamide, wood, veneer, wood composite, particle board, medium density fiberboard, cement, stone, glass, paper, cardboard, textiles, leather both synthetic and natural, composite substrates such as fiberglass composites or carbon fiber composites, 3-D printed polymers and composites, and the like.

As used herein, “vehicle” or variations thereof includes, but is not limited to, civilian, commercial and military aircraft, and/or land vehicles such as airplanes, helicopters, cars, motorcycles, and/or trucks. The shape of the substrate can be in the form of a sheet, plate, bar, rod or any shape desired.

Further, a “package” is anything used to contain another item, particularly for shipping from a point of manufacture to a consumer, and for subsequent storage by a consumer. A package will be therefore understood as something that is sealed so as to keep its contents free from deterioration until opened by a consumer. The manufacturer will often identify the length of time during which the food or beverage will be free from spoilage, which typically ranges from several months to years. Thus, the present “package” is distinguished from a storage package or bakeware in which a consumer might make and/or store food; such a package would only maintain the freshness or integrity of the food item for a relatively short period. “Package” as used herein means the complete package itself or any component thereof, such as an end, lid, cap, and the like. A package according to the present invention can be made of metal or non-metal, for example, plastic or laminate, and be in any form. An example of a suitable package is a laminate tube. Another example of a suitable package is metal can. The term “metal can” includes any type of metal can, package or any type of receptacle or portion thereof that is sealed by the food/beverage manufacturer to minimize or eliminate spoilage of the contents until such package is opened by the consumer. Packages coated with the composition of the present invention can also include plastic bottles, plastic tubes, laminates and flexible packaging, such as those made from PE, PP, PET and the like.

As indicated, the liquid coating composition is directly applied to at least a portion of the substrate to which the first material is applied. That is, the liquid coating composition is directly applied to at least a portion of the substrate to which the first material has been applied, such that the first material and the liquid coating composition are in contact with each other without any intermediate coating layers in between. The liquid coating composition can be applied to the substrate to which the first material is applied without any intervening steps such as drying or heating steps. Alternatively, an additional process step(s) can be conducted before applying the liquid coating composition including, but not limited to, drying by air and/or heating the first material. For example, the first material can be applied in a final deionized water rinse or in a pretreatment composition and then dried by air or heat before applying the liquid coating composition. The first material can also be applied to the substrate followed by a rinsing step.

As indicated, the liquid coating composition is directly applied to at least a portion of the substrate to which the first material is applied. That is, the liquid coating composition is directly applied to at least a portion of the substrate to which the first material has been applied, such that the first material and the liquid coating composition are in contact with each other without any intermediate coating layers in between. The liquid coating composition can be applied to the substrate to which the first material is applied without any intervening steps such as drying or heating steps. Alternatively, an additional process step(s) can be conducted before applying the liquid coating composition including, but not limited to, drying by air and/or heating the first material. For example, the first material can be applied in a final deionized water rinse or in a pretreatment composition and then dried by air or heat before applying the liquid coating composition. The first material can also be applied to the substrate followed by a rinsing step.

After application of the liquid coating composition, the first material can be localized at the interface or point of contact between the first material and the liquid coating composition. That is, the first material can be in contact with the liquid coating composition but does not migrate into the liquid coating composition. Alternatively, at least a portion of the first material can migrate into at least a portion of the liquid coating composition. For instance, the first material can migrate into a portion of the bulk region of the liquid coating composition.

The liquid coating composition can be applied to the substrate to which the first material is applied to form a monocoat. As used herein, a “monocoat” refers to a single coating layer that is free of additional coating layers. Thus, the liquid coating composition can be applied directly to a substrate and cured to form a single layer coating, i.e. a monocoat.

The coated substrate of the present invention may further comprise one or more additional coating layers, such as a second coating composition deposited onto at least a portion of the first liquid coating composition, to form a multi-layer coating such as by applying a topcoat. When a multi-layer coating is formed, the first liquid coating composition can be cured prior to application of additional coating compositions, or one or more of the additional coating compositions and the first liquid coating composition can be cured simultaneously. It is appreciated that the second coating composition and/or additional coating compositions can be in solid or liquid form.

The interaction between the liquid coating composition and the first material has been found to effect one or more aspects of the liquid coating composition. For example, the interaction between the liquid coating composition and the first material may cause a lower interfacial flow of the liquid coating composition in contact with at least a portion of the substrate to which the first material has been applied than the interfacial flow of the same liquid composition that is in contact with an identical substrate with the exception that no first material has been applied or with a portion of the same substrate to which the first material has not been applied. As such, when the liquid coating composition comes into contact with the first material that has been applied to the substrate, the flow of the liquid coating composition at the contacting interface with the first material can decrease and is therefore lower as compared to the same liquid coating composition not in contact with the first material. The interaction between the liquid coating composition and the first material may also produce a higher viscosity in the liquid coating composition than the viscosity of the same liquid coating composition that is not in contact with the first material. The viscosity increase of the liquid coating composition can be localized and increase at the interface of the first material, or can extend through all or part of the liquid coating composition.

The decrease in interfacial flow and the increase in viscosity of the liquid coating composition described herein can be demonstrated through various experiments including crosslink density and cure times. For instance, the coatings of the present invention have a higher crosslink density as compared to a coating deposited from the same the liquid coating composition applied over a substrate that is free of the first material. The first material applied to the substrate therefore decreases the interfacial flow and increases the viscosity of the liquid coating composition to allow better crosslinking.

The crosslink density can be tested with MEK (methyl ethyl ketone) double rubs in which the index finger of a tester holds a double thickness of cheesecloth saturated with MEK at a 45 degree angle to the coated panel surface. Each rub is performed with one stroke away from the tester and one return stroke toward the tester. The rubs are performed with moderate pressure at a rate of about 1 double rub per second and are at least 4″ long. The cheesecloths are remoistened with MEK every 25 to 50 rubs to ensure the applicator remains wet throughout the test. The double rubs are performed until failure of the coating where the coating is removed from the panel.

As indicated, the decrease in interfacial flow and the increase in viscosity of the liquid coating composition can also be shown by testing the cure times that the first material provides as compared to the cure times of the liquid coating composition without the first material. For instance, the first material can provide a significantly faster gel time when heated with the components of the liquid coating composition as compared to the gel time of the liquid coating composition that is free of the first material.

The degree of crosslinking is also demonstrated by other methods including, but not limited to, solvent soaking and thermomechanical analysis. In the solvent soaking test, coated substrates are soaked in a solvent such as acetone, for example for 24 hours. The coating thickness after solvent soaking is then compared to the coating thickness prior to solvent soaking. The greater the coating thickness retention after solvent soaking, the greater the degree of crosslinking. The coating thickness before and after solvent soaking is measured using 3D digital Macroscope.

For thermomechanical analysis, a Q400 thermomechanical analyzer from TA Instruments Inc. is utilized to investigate the crosslinked structure by monitoring temperature-driven penetration behavior. During such testing, a constant ramp of 10° C./min with a fixed force of 0.1 N can be applied in the temperature range of 25° C.-150° C. with the force being maintained until the system cooled down below 25° C. A full penetration of the entire coating demonstrates a lower crosslinking degree as compared to partial penetration or two step partial penetration behavior.

The interaction with the first material may also cause a higher crosslink density at the interface where the liquid coating composition contacted the first material. For example, the coating formed from liquid coating composition can have a higher crosslink density at a lower portion where the liquid coating composition contacted the first material such that the crosslink density is lower/decreases at a higher portion of the coating above the lower portion that contacted the first material.

After applying the liquid coating composition onto the substrate to which the first material is applied, at least a portion of the liquid coating composition can have a viscosity of greater than 100 cps as measured by a CAP2000 viscometer, commercially available from AMETEK Brookfield, and following the instructions contained in the CAP2000 viscometer manual. This test is referred to herein as the “viscosity test”.

As a result of the interaction between the first material and the liquid coating composition, reduced bare metal exposed area on edges as well as improved coating coverage over the edges and corners of the substrate has been observed. This may occur, for example, from a lower interfacial flow at an interface of the first material and the liquid coating composition, as well as from a higher viscosity of at least a portion of the liquid coating composition. For instance, the coated substrates of the present invention may have greater dry film thicknesses at the edges as compared to dry film thicknesses at the edges of substrates coated with the same composition but without the first material. The coated substrates of the present invention, for example, may have a dry film thickness at an edge of the substrate of 2 μm or greater, or 5 μm or greater, or 8 μm or greater, or 10 μm or greater, or 12 μm or greater. The coated substrates of the present invention may have a dry film thickness at an edge of the substrate of up to 25 μm, or up to 20 μm, or up to 15 μm. The coated substrates of the present invention may have a dry film thickness at an edge of the substrate within a range, such as for example, from 2 μm to 25 μm, or from 5 μm to 20 μm, or from 8 μm to 20 μm.

The coated substrates of the present invention may have a more consistent or uniform dry film thickness across the surface of the substrate as compared to substrates coated with the same composition but without the first material. That is, the dry film thicknesses at the edges of the coated substrates of the present invention may be more consistent with the dry film thickness at other portions of the substrate toward the center of the substrates, which are historically easier to coat as compared to the edges. For example, the coated substrate of the present invention may have a ratio of a dry film thickness at an edge of the substrate to a dry film thickness 10 mm away from the edge toward the center of the substrate within a range of from 1:3 to 1:15, or from 1:3 to 1:10, or from 1:4 to 1:12, or from 1:4 to 1:8.

The coated substrate of the present invention may have improved corrosion resistance due to improved coating coverage over the edges and corners of the substrate. Particularly, it was found that the coated substrates of the present invention may exhibit less than or equal to 10% linear edge corrosion after 20 or 40 cycles according to SAE J2334. During this corrosion testing, the coated substrates are cleaned, dried, and held against a template with 3 mm wide blocks after exposure. The percent (%) linear edge corrosion of the coated substrate is then determined by counting the number of marked square blocks on the substrate edges that exhibit corrosion products, blisters, and adhesion failure. The percent defects are calculated by taking the total number of squares with defects divided by the total number of squares from the evaluated edges. Good edge coverage is demonstrated with an average value of 3 test substrates below 20% linear edge corrosion, and excellent edge coverage is demonstrated with an average value of 5% or less linear edge corrosion. This linear edge corrosion testing is referred to herein as the “linear edge corrosion test”.

The coated substrate of the present invention may also have improved filiform corrosion resistance. Particularly, it was found that the coated substrates of the present invention may provide improved filiform corrosion resistance (tested in accordance with SAE J2635 “Filiform Corrosion Test Procedure for Painted Aluminum Wheels and Painted Aluminum Wheel Trim”), as compared to coated substrates not treated with the first material.

The coated substrate of the present invention may also have improved scribe corrosion resistance. Particularly, it was found that the coated substrates of the present invention may provide improved corrosion resistance when tested in accordance with ASTM-B117-18 and by applying a scribe down the middle of the substrate before measuring the total scribe creep, as compared to coated substrates not treated with the first material.

As indicted, the coated substrates may have good coating appearance. Particularly, the coated substrates of the present invention may have an R-value, which can be used to measure coating appearance, that is close to or the same as an R-value obtained from a substrate coated with the same composition but without the first material. For example, the coated substrates of the present invention have been found to have R-values of 75% or greater, or 80% or greater, or 85% or greater, or 90% or greater, or 95% or greater, or 100%, of an R-value of a substrate coated with the same composition but without the first material.

The R-values of the coated substrates, as reported herein, are determined by first measuring the longwaves and shortwaves of the coating substrate using a YK Wavescan Plus available from BYK-Gardner USA, which measures surface topography via an optical profile. The wave scan instrument uses a point source (i.e. laser) to illuminate the surface over a predetermined distance, for example 10 centimeters, at an angle of incidence of 60°. The reflected light is measured at the same, but opposite angle. As the light beam hits a “peak” or “valley” of the surface, a maximum signal is detected; when the beam hits a “slope” of a peak/valley a minimum signal is registered. The measured signal frequency is equal to double spatial frequency of the coating surface topography. Data are divided into longwave (structure size >0.6 mm) and shortwave (structure size <0.6 mm) signals using a mathematical filter function. The R-value is then determined within a scale of 0-10.5, with 10.5 signifying the best appearance. The calculation for R-Value is as follows: R=10.5−4*log (a−0.02*|b−20|), where a=20*(10\hat{ }(Longwave/67)−1) and b=20*(10\hat{ }(Shortwave/67)−1). If R>10.5, then R=10.5. If |b−20|>40, then |b−20|=40. This appearance testing is referred to herein as the “R-value test”.

Substrates coated according to the present invention may have one or more improved properties and/or may address one or more issues known in the coating industry. This may include, for example: improved coating edge coverage; more uniform coverage across the entire surface of a substrate including the edges and/or corners; improved sealing over the entire surface of a substrate including the edges and/or corners; increased sag resistance; improved adhesion; and/or improved chip resistance such as resistance during shipping and storing of the coated substrate. As used herein, “sag” refers to as the undesirable flow of the coating on vertical or near-vertical surfaces that produce films of unequal thickness. “Sag resistance” therefore refers to the resistance of the coating to flow on vertical or near-vertical surfaces.

The present invention also relates to methods including, for example, methods for treating a substrate, sealing at least a portion of a surface of a substrate, decreasing sag resistance, and/or improving edge coverage comprising: contacting at least a portion of the substrate with the first material; and directly contacting at least a portion of the substrate in contact with the first material with a liquid coating composition comprising a film-forming resin, and optionally a crosslinker reactive with the film-forming resin to form a coating layer. The methods of the present invention cause the liquid coating composition to come into contact with the first material. The resulting interaction between the liquid coating composition and the first material provided by the method of the present invention effects one or more aspects of the coating composition as previously described including, for example, a lower interfacial flow of the liquid coating composition and/or a higher viscosity of the liquid coating composition as compared to the interfacial flow or viscosity of the same liquid composition that is in contact with an identical substrate with the exception that no first material has been applied or with a portion of the same substrate to which the first material has not been applied.

The first material and liquid coating composition used in the methods of the present invention include any of the first materials and liquid coating compositions previously described. The first material can also be applied to the substrate, such as directly to the substrate without any intermediate layers, using any of the previously described methods including, for example, dipping, rinsing, wiping, spraying, vapor or electrodepositing, brushing, rolling, or blasting.

The methods of the present invention can also include any of the additional steps described herein. For example, the methods of the present invention can also comprise: treating, plating, and/or applying a pretreatment composition to the substrate before applying the first material; drying the substrate after applying the first material by air and/or heat; and/or applying one or more additional coating compositions.

The substrates coated according to the methods of the invention may include any of the previously described substrates and materials. Different steps can be used to coat certain substrates and materials for particular end uses and applications. For example, a coil can be coated by contacting at least a portion of a coil with the first material, rolling the coil for storage and/or shipping, unrolling the coil at later period of time, and then directly contacting at least a portion of the coil in contact with the first material with a liquid coating composition comprising a film-forming resin, and optionally a crosslinker reactive with the film-forming resin to form a coating layer of the liquid coating composition on the substrate. The coil can also be stamped or formed before or after applying the liquid coating composition.

As indicated, the liquid coating composition can comprise an electrodepositable coating composition. As such, the present invention can also comprise electrophoretically depositing onto at least a portion of the substrate to which the first material has been applied an electrodepositable coating composition comprising a film-forming resin, and optionally a crosslinker reactive with the film-forming resin. A cationic electrodepositable coating composition may be deposited upon an electrically conductive substrate by placing the composition in contact with an electrically conductive cathode and an electrically conductive anode, with the surface to be coated being the cathode. Alternatively, an anionic electrodepositable coating composition of the present invention may be deposited upon an electrically conductive substrate by placing the composition in contact with an electrically conductive cathode and an electrically conductive anode, with the surface to be coated being the anode.

Following contact with the composition, an adherent film of the coating composition is deposited on the cathode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the cationic electrodepositable coating composition is electrodeposited over at least a portion of the electroconductive substrate, the coated substrate may be heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating.

The electrodepositable coating compositions of the present invention may also, if desired, be applied to a substrate using non-electrophoretic coating application techniques, such as flow, dip, spray and roll coating applications as previously described.

The methods of the present invention cause the electrodepositable coating composition to come into contact with the first material. The resulting interaction between the coating composition and the first material provided by the method of the present invention effects one or more aspects of the electrodepositable coating composition as previously described including, for example, a lower interfacial flow of the electrodepositable coating composition and/or a higher viscosity of the electrodepositable coating composition as compared to the interfacial flow or viscosity of the same electrodepositable composition that is in contact with an identical substrate with the exception that no first material has been applied or with a portion of the same substrate to which the first material has not been applied.

The following examples are presented to demonstrate the general principles of the invention. The invention should not be considered as limited to the specific examples presented. All parts and percentages in the examples are by weight unless otherwise indicated.

### Examples 1 and 2

### Preparation and Application of Treatment Solutions Containing Catalyst

Solutions containing a catalyst were first prepared from the components listed in Table 1.

TABLE 1

| | Example 1 | Example 2 |
|---|---|---|
| Components | (grams) | (grams) |
| De-ionized water | 190.0 | 190.0 |
| 1,4-diazabicyclo[2.2.2]octane ¹ | 10.0 | 20 |
| TRITON CF-10 ² | 0.13 | 0.13 |
| Hydromax ® 300 ³ | 2.5 | 2.5 |

¹ Triethylenediamine catalyst, commercially available from Evonik Industries.
² A nonionic surfactant commercially available from DOW.
³ A hydrotrope, nonionic surfactant solubilizer, and electrostatic agent, commercially available from Alfa Chemicals.

Examples 1 and 2 were weighed into separate containers and mixed with a wooden spatula until homogeneous.

### Example 3

### Preparation of a Liquid Coating Composition

A liquid coating composition was prepared from the components listed in Table 2. The components of the liquid coating composition were added in the order listed and stirred with a wooden spatula after each addition.

TABLE 2

| Components | Amount (grams) |
|---|---|
| Ebecryl ® 895⁴ | 64.4 |
| n-butyl acetate | 60.0 |
| BYK-300⁵ | 0.55 |
| Tinuvin ® 400⁶ | 1.4 |
| Tinuvin ® 292⁷ | 0.7 |
| Catalyst solution⁸ | 2.83 |
| ThioCure PETMP⁹ | 74.9 |

⁴Penta-functional acrylate, commercially available from Allnex.
⁵Polydimethylsiloxane flow additive, commercially available from BYK-Chemie GMBH.
⁶Hydroxyphenyl triazine UV absorber, commercially available from BASF.
⁷Hindered amine light stabilizer, commercially available from BASF.
⁸5 wt % solution of triethylenediamine in n-butyl acetate.
⁹Pentaerythritol tetrakis (3-mercaptopropionate), commercially available from BRUNO BOCK Chemische Fabrik GmdH & Co. KG.

### Example 4

### Preparation and Evaluation of Coated Substrates

Half of a 4 inch by 12 inch of separate metal panels were submerged in the treatment solutions of Examples 1 and 2 for 1 minute. Upon removal, the submerged portions were dried using a forced air handheld dryer. The panels were then coated with the formulation from Example 3 on both sides of the panels using a Devilbiss HVLP gun equipped with a 1.4 mm nozzle and 30 psi of pressure. The resulting panels were then cured at room temperature for 24 hours.

The coated substrates were tested by the R-value test previously described herein. The average edge coverage of each coated substrate was also tested.

The edge coverage was tested using FE-SEM Analysis. For the edge coverage test, small square sections were cut from an area of each panel with no surface treatment (top right, top left), and an area with surface treatment (bottom right, and bottom left edges) with a panel cutter and mounted in epoxy overnight. After curing, the mounts were ground, polished, and placed on aluminum stubs with carbon tape. Samples were then coated with Au/Pd for 20 seconds and analyzed in a Quanta 250 FEG SEM under high vacuum. The accelerating voltage was set to 20.00 kV and the spot size was 3.0. The samples were viewed in both secondary and back-scatter mode depending on which image allowed the best contrast. Three dry film thickness measurements were collected from around the front and back panel edges and averaged to provide average edge coverage measurements for each area. The measurements were taken at the thinnest part of the coating at the edge of the substrate.

The test results of the R-value and average edge coverage are listed in Table 3.

TABLE 3

| | R-value | R-value | μm Average | μm Average |
|---|---|---|---|---|
| Treatment | untreated | treated | edge coverage | edge coverage |
| solution | top | bottom | untreated top | treated bottom |
| Example 1 | 5.1 | 3.9 | 2.6 | 5.9 |
| Example 2 | 6 | 4.4 | 2.1 | 3.9 |

As shown in Table 3, the portions of the coated substrates treated with the catalyst solutions all exhibited good R-values and improved edge coverage as compared to the untreated portions of the coated substrates.

### Example 5

### Preparation of a Treatment Solution Containing Catalyst

A 2% solution of dibutyltin dilaurate was first prepared from the components listed in Table 4.

TABLE 4

| Components | Amount (grams) |
|---|---|
| n-butyl acetate | 392 |
| dibutyltin dilaurate | 8 |

Dibutyltin dilaurate was added to the n-butyl acetate and mixed using a wooden spatula until a homogeneous mixture was formed.

### Example 6

### Preparation of a Liquid Coating Composition

A liquid coating composition was prepared by mixing the components listed in Table 5.

TABLE 5

| Components | Amount (grams) |
|---|---|
| D8173 ¹⁰ | 161 |
| D8302 ¹¹ | 58 |
| D8718 ¹² | 27 |

¹⁰ A hydroxyl functional polymer, commercially available from PPG.
¹¹ Mixture of polymeric isocyanates, commercially available from PPG.
¹² Solvent mixture, commercially available from PPG.

### Example 7

### Preparation and Evaluation of Coated Substrates

Test panels were attached to a T-shaped metal spray apparatus and dipped into the 2% solution of dibutyltin dilaurate of Example 5 until the panels were half submerged. The panels were left in the solution for approximately 10 seconds. The solvent was then allowed to evaporate off of the panels. All 6 edges of each panel were then sprayed with the liquid coating composition of Example 6 using a SATA jet 5000 B RP with a 1.3 mm nozzle at 25 psi. The liquid coating composition was applied in one coat on all sides. A final dry film thickness of 2.0-2.5 mils was targeted for each panel. Panels were flashed overnight in ambient conditions. The test results of the R-value and average edge coverage are listed in Table 6.

TABLE 6

| | R-value | R-value | μm Average | μm Average |
|---|---|---|---|---|
| Treatment | untreated | treated | edge coverage | edge coverage |
| solution | top | bottom | untreated top | treated bottom |
| Panel 1 | 8.4 | 6.5 | 4.0 | 3.7 |
| Panel 2 | 7.6 | 6.8 | 1.3 | 2.5 |

As shown in Table 6, the portions of the coated substrates treated with the catalyst solutions all exhibited good R-values and the panels showed that the edge cover could be improved by using the solutions.

### Example 8

### Preparation of a Crosslinker for a Cationic Resin

A crosslinker for inclusion in a cationic film-forming binder was prepared from the components listed in Table 7.

TABLE 7

| Charge | Component | Amount (g) |
|---|---|---|
| 1 | Toulene Diisocyanate | 919.56 |
| 2 | Methyl Isobutyl Ketone | 507.34 |
| 3 | Dibutyl Tin Di-Laurate | 1.06 |
| 4 | Trimethylol Propane | 59.25 |
| 5 | Trimethylol Propane | 59.25 |
| 6 | Trimethylol Propane | 59.25 |
| 7 | Trimethylol Propane | 59.25 |
| 8 | Methyl Isobutyl Ketone | 63.42 |
| 9 | Butyl Glycolamide | 702 |
| 10 | Methyl Isobutyl Ketone | 60.25 |
| 11 | Ethoxylated Bisphenol A Polyol | 217 |
| 12 | Dowanol PPH Low phenol grade ¹³ | 289.4 |
| 13 | Methyl Isobutyl Ketone | 2.96 |

¹³ Glycol ether low phenol grade, commercially available from Dow.

Charges 1, 2, and 3 were added to a flask with N₂ and heated to 35° C. Charge 4 was then added monitoring the exotherm. After peak temperature was reached, the mixture was held for 30 minutes at 55° C. Charge 5 was then added monitoring the exotherm. After peak temperature was reached, the mixture was held for 30 minutes at 57° C. Charge 6 was then added monitoring the exotherm. After peak temperature was reached, the mixture was held for 30 minutes at 59° C. Charge 7 was then added monitoring the exotherm. After peak temperature was reached, the mixture was held for 45 minutes at 95° C. Charge 8 was then added and the mixture was held for 1 hour at 95° C. The mixture was then cooled to 70° C. and charge 9 was slowly fed in over 1-2 hours keeping maximum temperature less than 100° C. After charge 9 was completely added, the mixture was held for one hour at 105° C. Isocyanate level was monitored and the mixture was held at 105° C. until Isocyanate levels were gone. After Isocyanate was gone, charge 10 was added and mixed until homogeneous. Charges 11, 12, and 13 were then added while maintaining a temperature between 105° C.-110° C. The mixture was then stirred for 30 minutes and was poured off.

### Example 9

### Preparation of a Cationic Resin and Cationic Electrocoat Bath

Part A: A cationic film-forming binder was prepared from the components listed in Table 8.

TABLE 8

| Charge | Component | Amount (g) |
|---|---|---|
| 1 | Epon ™ 880 ¹⁴ | 1152.3 |
| | Bisphenol A | 504.9 |
| | Methyl Isobutyl Ketone | 151.1 |
| 2 | Ethyltriphenyl Phosphonium Bromide | 1.15 |
| 3 | Dowanol PPH Low phenol grade ¹³ | 163.5 |
| 4a | Diketimine | 121.1 |
| 4b | N-Methyl Ethanolamine | 103.3 |
| 5 | Crosslinker from Example 8 | 1680 |
| 6 | Deionized Water | 1980.2 |
| | Formic Acid | 67.9 |
| 7 | Deionized Water | 2012.4 |
| 8 | Deionized Water | 1687.3 |

¹⁴ Epoxy functional resin, commercially available from Hexion.

Charges 1 and 2 were added to a 3 liter flask, heated to 132° C., and stirred under an N₂ blanket. It was then held at 145° C. for hone hour. It was then cooled to 92° C. and charge 3 was added. Charge 4a followed by charge 4b were then added and the mixture was held for 1 hour at 110° C. The mixture was then cooled to 95° C. and charge 5 was added. The mixture was then held for 2 hours. Charge 6 was preheated to 43° C. The resin mixture was reverse drilled into the preheated charge 6 and then held for 1 hour at 65° C. Charge 7 was then added and the mixture was held for 30 minutes. Charge 8 was added and let stir for 45 minutes. The resin was added to a 12 liter flask and heated to 63° C. The resin was then vacuum distilled for 4.5 hours removing 2213.6 g.

Part B: A cationic electrocoat bath was prepared from the components listed in Table 9.

TABLE 9

| Charge | Component | Amount (g) |
|---|---|---|
| 1 | Cationic Resin of Part A | 598.2 |
| 2 | MAZON 1651 ¹⁵ | 22 |
| 3 | Deionized Water | 1579.8 |

¹⁵ Plasticizer, commercially available from BASF.

The cationic electrocoat bath was prepared by thinning 598.2 grams of charge 1 with 1579.8 grams of charge 3 while under mild agitation. Then, 22 grams of charge 2 was added to the bath and was mixed under mild agitation for one hour.

### Example 10

### Preparation of a Catalyst Solution and Treatment of Substrates

Part A: A solution containing a cure catalyst for cationic electrodepositable coatings was prepared from the components listed in Table 10.

TABLE 10

| Charge | Component | Amount (g) |
|---|---|---|
| 1 | Catalyst Containing Grind Vehicle¹⁶ | 300 |
| 2 | Laponite RD ®¹⁷ | 5 |
| 3 | Deionized Water | 1000 |

¹⁶A cationic grind vehicle containing cyclic guanidine, prepared as described in Example 15 of U.S. Pat. No. 8,884,059, which is incorporated by reference herein.
¹⁷Synthetic clay, commercially available from BYK Additives Inc.

Charge 2 was dispersed into charge 3 with a high speed dispersion blade for 10 minutes. After that, charge 1 was added and then allowed to mix for 1 hour. The final mixture contained 1% of catalyst by weight of solution.

Part B: Two Chemfos 700 No Chemseal Knife Blades, purchased from ACT (Item no. 55493), were allowed to soak in the modified catalyst solution described in Part A for one minute. The knife blades were then allowed to dry in an ambient environment while being held with the blade side up and tilted 60 degrees from the horizontal plane. After 10 minutes of ambient drying, the blades were then baked at 110° C. for an additional 10 minutes while remaining in the same tilted position.

### Example 11

### Electrodeposition of an Electrocoat Composition and Evaluation of Coated Substrates

Part A: The two treated knife blades described in Example 10 were electrocoated with the electrocoat composition described in Example 9. Additionally, two Chemfos 700 No Chemseal Knife Blades that had not been treated were also electrocoated with the composition described in Example 9. The electrodeposition and bake parameters are described in Table 11.

TABLE 11

| | | | Film |
|---|---|---|---|
| Substrate | Electrodeposition | Bake | Build |
| Description | Parameters | Parameters | (mils) |
| Treated Knife | 200 Volts, 90° F. | 30 minutes 250° F. | 1.06 |
| Blade 1 | Bath Temperature, | followed by 30 | |
| | 120 seconds | minutes 350° F. | |
| Treated Knife | 200 Volts, 90° F. | 30 minutes 250° F. | 0.93 |
| Blade 2 | Bath Temperature, | followed by 30 | |
| | 120 seconds | minutes 350° F. | |
| Untreated Knife | 200 Volts, 90° F. | 30 minutes 250° F. | 1.10 |
| Blade 1 | Bath Temperature, | followed by 30 | |
| | 120 seconds | minutes 350° F. | |
| Untreated Knife | 200 Volts, 90° F. | 30 minutes 250° F. | 1.18 |
| Blade 2 | Bath Temperature, | followed by 30 | |
| | 120 seconds | minutes 350° F. | |

Part B: The electrocoated knife blades described in Part A were evaluated for edge coverage performance by counting rust spots along the knife's edge after 7 day according to ASTM B117-18 with 500 salt fog exposure. During salt fog exposure, each blade was taped to an aluminum backer panel at an angle of 45 degrees from horizontal with the sharp edge facing up. After salt fog exposure, the coated substrates were rinsed with DI water and allowed to dry. Rust spots along the sharp edges were then counted by hand using a magnifying glass. The results are provided in Table 12.

TABLE 12

| Substrate Description | Counted Number of Rust Spots | Average |
|---|---|---|
| Electrocoated Treated | 40 | 38 |
| Knife Blade 1 | | |
| Electrocoated Treated | 36 | |
| Knife Blade 2 | | |
| Electrocoated Untreated | 54 | 49.5 |
| Knife Blade 1 | | |
| Electrocoated Untreated | 45 | |
| Knife Blade 2 | | |

As shown in Table 12, the coated knifes treated with the catalyst solution had less rust spots along edge as compared to the coated knifes not treated with the catalyst solution. The coated knifes treated with the catalyst solution therefore had better coated edge coverage.

The present invention also relates to the following clauses.

Clause 1: A substrate comprising: (a) a first material applied to at least a portion of the substrate; and (b) a continuous film deposited from a curable liquid coating composition comprising a film forming resin having functional groups, and optionally a crosslinker that is reactive with the functional groups of the film forming resin, in contact with at least a portion of the substrate to which the first material has been applied, wherein the first material is (i) a catalyst that catalyzes cure of the liquid coating composition, (ii) a component reactive with the film-forming resin and/or the crosslinker of the liquid coating composition, and/or (iii) a rheology modifier.

Clause 2: The substrate of clause 1, wherein the film forming resin is dispersed and/or dissolved in an aqueous or non-aqueous liquid medium of the liquid coating composition.

Clause 3: The substrate of any of the preceding clauses, wherein an interfacial flow of the liquid coating composition in contact with a portion of the substrate to which the first material has been applied is lower than an interfacial flow of the same liquid composition that is in contact with an identical substrate with the exception that no first material has been applied or with a portion of the same substrate to which the first material has not been applied.

Clause 4: The substrate of any of the preceding clauses, wherein a viscosity of the liquid coating composition upon and/or after contact with the first material is higher than the viscosity of the same liquid coating composition without contact to the first material.

Clause 5: The substrate of any of the preceding clauses, wherein the first material is localized at the interface where the liquid coating composition comes into contact with the first material.

Clause 6: The substrate of any of clauses 1 to 4, wherein the first material migrates into at least a portion of the liquid coating composition.

Clause 7: The substrate of any of the preceding clauses, wherein the first material is the catalyst that catalyzes cure of the liquid coating composition.

Clause 8: The substrate of any of the preceding clauses, wherein the first material is the component reactive with the film-forming resin and/or the crosslinker of the liquid coating composition.

Clause 9: The substrate of clause 8, wherein the first material comprises a crosslinker, a resin, a reactive diluent, a monomer, or a combination thereof that is reactive with the film-forming resin and/or the crosslinker of the liquid coating composition.

Clause 10: The substrate of any of the preceding clauses, wherein the first material is the rheology modifier.

Clause 11: The substrate of clause 10, wherein the rheology modifier comprises silica, chemically modified silica, alumina, chemically modified alumina, a hydrophobically modified ethylene-oxide polymer, a rubber latex, or any combination thereof.

Clause 12: The substrate of any of the preceding clauses, wherein the first material prior to application is dispersed or dissolved in a liquid medium.

Clause 13: The substrate of clause 12, wherein the liquid medium is an aqueous liquid medium.

Clause 14: The substrate of any of the preceding clauses, wherein the first material is applied directly over at least a portion of the substrate.

Clause 15: The substrate of any of the preceding clauses, wherein the first material is included in a pretreatment composition applied to at least a portion of the substrate.

Clause 16: The substrate of clause 15, wherein there is a greater concentration of the first material in a surface region of the pretreatment composition applied to at least a portion of the substrate than a bulk region of the pretreatment composition applied to at least a portion of the substrate.

Clause 17: The substrate of any of clauses 1-13, wherein the substrate further comprises a pretreatment layer and the first material is applied over at a least portion of the pretreatment layer.

Clause 18: The substrate of claim 1-13, wherein the substrate further comprises a coating layer and the first material is applied over at a least portion of the coating layer.

Clause 19: The substrate of any of the preceding clauses, wherein after application to the substrate, at least a portion of the liquid coating composition has a viscosity of greater than 100 cps as measured by the viscosity test.

Clause 20: The substrate of any of the preceding clauses, wherein the liquid coating composition is physisorbed onto the substrate.

Clause 21: The substrate of any of the preceding clauses, wherein the first material is physisorbed on the substrate.

Clause 22: The substrate of any of the preceding clauses, wherein the first material is chemisorbed on the substrate.

Clause 23: The substrate of any of the preceding clauses, further comprising a second coating composition applied over at least a portion of a coating formed from the liquid coating composition of (b).

Clause 24: The substrate of any of the preceding clauses, wherein the substrate is a metallic substrate.

Clause 25: The substrate of any of the preceding clauses, wherein the substrate is a non-metallic substrate.

Clause 26: The substrate of any of the preceding clauses, wherein the substrate comprises cold rolled steel, hot rolled steel, steel coated with zinc metal, zinc compounds, zinc alloys, electrogalvanized steel, hot-dipped galvanized steel, galvannealed steel, steel plated with zinc alloy, stainless steel, zinc-aluminum-magnesium alloy coated steel, aluminum, aluminum alloys, aluminum plated steel, aluminum alloy plated steel, magnesium, magnesium alloys, nickel, brass, copper, silver, gold, plastic, or any combination thereof.

Clause 27: The substrate of any of the preceding clauses, wherein the substrate is a fastener, coiled metal, a vehicle, a package, a heat exchanger, a vent, an extrusion, roofing, flooring, a wheel, a grate, a belt, a conveyor, an aircraft, an aircraft component, a vessel, a marine component, a vehicle, a building, an electrical component, a grain or seed silo, wire mesh, a screen or grid, HVAC equipment, a frame, a tank, a cord, a wire, or any combination thereof.

Clause 28: The substrate of any of the preceding clauses, wherein the liquid coating composition is an electrodepositable coating composition.

Clause 29: A method for treating a substrate: (a) contacting at least a portion of the substrate with a first material; and (b) directly contacting at least a portion of the substrate in contact with the first material with a liquid coating composition comprising a liquid medium, a film forming resin having functional groups, and optionally a crosslinker that is reactive with the functional groups of the film forming resin, to form a continuous film of the liquid coating composition on the substrate, wherein the first material is (i) a catalyst that catalyzes cure of the liquid coating composition, (ii) a component reactive with the film-forming resin and/or the crosslinker of the liquid coating composition, and/or (iii) a rheology modifier.

Clause 30: The method of clause 29, wherein step (a) comprises dipping the substrate in a bath that comprises the first material.

Clause 31: The method of clause 30, wherein the bath comprises a pretreatment bath.

Clause 32: The method of clause 31, wherein the pretreatment bath is a cleaner bath, a deoxidizer bath, a cleaner-coater bath, a rinse conditioner bath, a pretreatment coating bath, a rinsing bath, a sealing bath, or a deionized water rinsing bath.

Clause 33: The method of clause 29, wherein the first material is contained on and/or in a wipe and step (a) comprises wiping the substrate.

Clause 34: The method of clause 29, wherein the first material is contained in a liquid formulation and the liquid formulation is sprayed onto the substrate in step (a).

Clause 35: The method of clause 34, wherein the liquid formulation further comprises a surfactant.

Clause 36: The method of clause 29, wherein the first material is deposited onto the substrate by electrodeposition or vapor deposition in step (a).

Clause 37: The method of clause 29, wherein the first material is bushed or rolled onto the substrate in step (a).

Clause 38: The method of clause 29, wherein the first material is a solid and is blasted onto the substrate in step (a) or electrostatically sprayed as a powder onto the substrate in step (a).

Clause 39: The method of clause 29, wherein the substrate is cleaned and coated with the first material in a single step.

Clause 40: The method of clause 29, wherein the substrate is plated with a metal prior to step (a).

Clause 41: The method of clause 29, wherein the substrate comprises an anodized, cast, or forged metal.

Clause 42: The method of any of the clauses 29-41, wherein first material is applied directly to the substrate.

Clause 43: The method of any of clauses 29-42, wherein the substrate is treated prior to step (a).

Clause 44: The method of clause 43, wherein, prior to step (a), the substrate is alkaline cleaned, deoxidized, mechanically cleaned, ultrasonically cleaned, plasma cleaned or etched, exposed to chemical vapor deposition, treated with an adhesion promoter, or any combination thereof.

Clause 45: The method of clause 43, wherein the substrate is pretreated prior to step (a) with a pretreatment composition.

Clause 46: The method of clause 45, wherein the pretreatment composition comprises a sol-gel, iron phosphate, manganese phosphate, zinc phosphate, a rare earth metal, permanganate, zirconium, titanium, a silane, trivalent chrome, chromate, a silicate, molybdenum, a lanthanide, a metal chelate, a metal oxide, hydrotalcite, phosphonic acid, layered double hydroxide, or any combination thereof.

Clause 47: The method of clauses 45 or 46, wherein, after pretreatment, the substrate is rinsed with, sprayed with, or wiped with a solution that comprises the first material in step (a).

Clause 48: The method of any of clauses 45-47, wherein the pretreatment composition is dried after application.

Clause 49: The method of any of clauses 29 to 48, further comprising step (c), contacting at least a portion of the substrate with a second coating composition.

Clause 50: The method of any of the clauses 29 to 49, wherein the first material is dried by air and/or heat after step (a).

Clause 51: The method of any of clauses 29-50, wherein there is no intervening step between step (a) and step (b).

Clause 52: The method of any of clauses 29-51, wherein the dry film thickness of the coating formed from the liquid coating composition at the edge of the substrate is 2 μm or greater.

Clause 53: A method for treating a coil comprising: (a) contacting at least a portion of the coil with a first material; (b) rolling the coil; (c) unrolling the coil; and (d) directly contacting at least a portion of the coil in contact with the first material with a liquid coating composition comprising a liquid medium, a film forming resin having functional groups and optionally a crosslinker that is reactive with the functional groups of the film forming resin, wherein the first material is (i) a catalyst that catalyzes cure of the liquid coating composition, (ii) a component reactive with a film-forming resin and/or a crosslinker of the liquid coating composition, and/or (iii) a rheology modifier.

Whereas particular embodiments of this invention have been described above for purposes of illustration, it will be evident to those skilled in the art that numerous variations of the details of the present invention may be made without departing from the invention as defined in the appended claims.

1. A substrate comprising:
a. a first material applied to at least a portion of a substrate; and
b. a coating layer deposited from a liquid coating composition in direct contact with at least a portion of the substrate to which the first material has been applied, the liquid coating composition comprising a film-forming resin, and optionally a crosslinker that is reactive with the film-forming resin, and
wherein the first material is (i) a catalyst that catalyzes cure of the liquid coating composition, (ii) a component reactive with the film-forming resin and/or the crosslinker of the liquid coating composition, and/or (iii) a rheology modifier.

2. The substrate of claim 1, wherein an interfacial flow of the liquid coating composition in contact with at least a portion of the substrate to which the first material has been applied is lower than the interfacial flow of the same liquid composition that is in contact with an identical substrate with the exception that no first material has been applied.

3. The substrate of claim 1, wherein a viscosity of the liquid coating composition upon and/or after contact with the first material is higher than a viscosity of the same liquid coating composition that is in contact with an identical substrate with the exception that no first material has been applied.

4. The substrate of claim 1, wherein the first material is localized at the interface where the liquid coating composition comes into contacts with the first material.

5. The substrate of claim 1, wherein the first material migrates into at least a portion of the liquid coating composition.

6. The substrate of claim 1, wherein the first material is the catalyst that catalyzes cure of the liquid coating composition.

7. The substrate of claim 1, wherein the first material is the component reactive with the film-forming resin and/or the crosslinker of the liquid coating composition.

8. The substrate of claim 7, wherein the first material comprises a crosslinker, a resin, a reactive diluent, a monomer, or a combination thereof that is reactive with the film-forming resin and/or the crosslinker of the liquid coating composition.

9. The substrate of claim 1, wherein the first material is the rheology modifier.

10. The substrate of claim 9, wherein the rheology modifier comprises silica, chemically modified silica, alumina, chemically modified alumina, a hydrophobically modified ethylene-oxide polymer, a rubber latex, or any combination thereof.

11. The substrate of claim 1, wherein the first material prior to application is dispersed or dissolved in a liquid medium.

12. The substrate of claim 11, wherein the liquid medium is an aqueous liquid medium.

13. The substrate of claim 1, wherein the first material is applied directly over at least a portion of the substrate.

14. The substrate of claim 1, wherein the first material is included in a pretreatment composition applied to at least a portion of the substrate.

15. The substrate of claim 14, wherein there is a greater concentration of the first material in a surface region of the pretreatment composition applied to at least a portion of the substrate than a bulk region of the pretreatment composition applied to at least a portion of the substrate.

16. The substrate of claim 1, wherein the substrate further comprises a pretreatment layer and the first material is applied over at a least portion of the pretreatment layer.

17. The substrate of claim 1, wherein the substrate further comprises a coating layer and the first material is applied over at a least portion of the coating layer.

18. The substrate of claim 1, wherein after application to the substrate, at least a portion of the liquid coating composition has a viscosity of greater than 100 cps as measured by the viscosity test.

19. The substrate of claim 1, wherein the liquid coating composition is physisorbed onto the substrate.

20. The substrate of claim 1, wherein the first material is physisorbed on the substrate.

21. The substrate of claim 1, wherein the first material is chemisorbed on the substrate.

22. The substrate of claim 1, further comprising a second coating composition applied over at least a portion of the coating layer formed from the liquid coating composition of (b).

23. The substrate of claim 1, wherein the substrate is a metallic substrate.

24. The substrate of claim 1, wherein the substrate comprises cold rolled steel, hot rolled steel, steel coated with zinc metal, zinc compounds, zinc alloys, electrogalvanized steel, hot-dipped galvanized steel, galvannealed steel, steel plated with zinc alloy, stainless steel, zinc-aluminum-magnesium alloy coated steel, aluminum, aluminum alloys, aluminum plated steel, aluminum alloy plated steel, magnesium, magnesium alloys, nickel, brass, copper, silver, gold, plastic, or any combination thereof.

25. The substrate of claim 1, wherein the substrate is a fastener, coiled metal, a vehicle, a package, a heat exchanger, a vent, an extrusion, roofing, flooring, a wheel, a grate, a belt, a conveyor, an aircraft, an aircraft component, a vessel, a marine component, a vehicle, a building, an electrical component, a grain or seed silo, wire mesh, a screen or grid, HVAC equipment, a frame, a tank, a cord, a wire, or any combination thereof.

26. The substrate of claim 1, wherein the coating layer formed from the liquid coating composition applied over the substrate to which the first material has been applied has an R-value of 75% or greater as compared to an R-value of a coating layer formed from the liquid coating composition applied over a substrate that is free of the first material, where R-value is measured by the R-value test.

27. The substrate of claim 1, wherein a dry film thickness at an edge of the coating layer formed from the liquid coating composition is 2 μm or greater.

28. The substrate of claim 1, wherein a ratio of the dry film thickness of the coating layer formed from the liquid coating composition at the edge and at 10 mm away from the edge into the center is from 1:3 to 1:15.

29. The substrate of claim 1, wherein the liquid coating composition is an electrodepositable coating composition.

30-58. (canceled)

59. The substrate of claim 1, wherein the first material applied to the substrate forms a pretreatment layer having a thickness of less than 2.5 microns.

60. The substrate of claim 1, wherein liquid coating composition is a thermosetting liquid coating composition.
